(19) United States
(12) Patent Application Publication
(10) Pub. No.: US 2006/0185340 A1
(43) Pub. Date: Aug. 24, 2006

(54) Cutting and threshing header for harvesting machine

(76) Inventor: Robert John Eyre, Alford (GB)

Correspondence Address: Thomas E. Sisson;Jackson Walker, LLP, Suite 2100, 112 E. Pecan, San Antonio, TX, 78205, US

(21) Appl. No.: 11/385,425

(22) Filed: Mar. 21, 2006

Related U.S. Application Data
(63) Continuation-in-part of application No. 10/332,093, filed on May 19, 2003.

(51) Int. Cl. A01D 41/00

(52) U.S. Cl. 56/122

(57) ABSTRACT

A cutting and threshing header for attachment to an agricultural vehicle for use in harvesting standing crops. The header comprises cutters for cutting crop material including seeds or grains and varying lengths of stalk, said cutting means extending over substantially the full width of the header. Threshing stages within the header also extend over a width substantially equal to the width of the cutting means. The threshing means comprises a curved mesh surface extending over the full width of the threshing means and a rotor co-operating with said mesh surface to urge the cut crop material through an annular space between the rotor and the mesh, thereby causing separation of said cut crop material into seeds or grains, which pass through said mesh for collection, and waste material including said varying lengths of stalk, which is discharged from the threshing means over substantially the full width thereof.

This is a continuation-in-part of and claims priority from co-pending U.S. patent application Ser. No. 10/332,093, filed on May 19, 2003, entitled “Harvesting Machine,” the entire content of which is hereby incorporated by reference.

### FIELD OF THE INVENTION

This invention relates to a cutting and threshing header for attachment to an agricultural vehicle for use in harvesting standing crops and to a harvesting machine comprising such a header attached to an agricultural vehicle.

### BACKGROUND TO THE INVENTION

Conventional harvesting machines for grain and seeds separate the cutting of the crop and the threshing to extract the grain or seeds from the rest of the cut crop material into two distinct stages. In order to maximize the rate of harvesting, it may seem desirable to widen the cutting stage as much as possible so as to cut a wide swathe through the crop. However, because the cut material is then funneled into the threshing stage of the machine, the wider the cutting stage is made, the greater is the capacity of the threshing stage required to handle the volume of cut material passed thereto. It is not practical simply to make the threshing stage larger in size, since the resultant machine would be too large to transport, and too large to use in smaller spaces. It is necessary, therefore, to attempt to increase the speed and power of the threshing stage, and in practice the advantages of higher harvesting rate are offset by the greater cost and power consumption of the machine.

One problem is that the threshing stage has to handle a very high volume of cut crop material, most of which is then discharged back on to the field to be collected or processed in a separate operation subsequently. Another problem is that the cut crop material is funneled into a relatively narrow width in the machine for threshing.

U.S. Pat. No. 4,896,486 (Lundahl et al) discloses a harvesting machine having a stripper header which has upper and lower rotating stripping elements which remove the grain from the stalks by a percussion or impact action. The result of this is that, firstly, the stalks are left standing in the field and, secondly, the resulting material to be handled by the header consists largely of grain and chaff; the inclusion of stalks/straw, if it occurs at all, is minimal and accidental. The header is therefore not required to carry out a threshing action to separate grain from cut waste crop material such as stalks and straw.

While the Lundahl et al arrangement may be acceptable for grain crops such as wheat, and for cultivation regimes that do not require the straw to be cut and gathered for further use, or chopped for incorporation into the soil, many types of seed-bearing crop cannot readily be harvested by stripping, and separate processing would be required to chop the straw or collect it, where this is required.

Australian Patent No 2164283 (Winston) discloses another example of a stripper header adapted to minimize the quantity of straw/stalk removed from the standing crop for subsequent processing. It has a belt separator which is adapted to remove chaff and any residual waste crop material from the grain, but the configuration is such that threshing of the complete cut crop to separate out the grain would not be possible; the header is essentially designed to clean a stripped crop.

An object of the invention is therefore to provide a header which can provide rapid harvesting and threshing of fully cut seed/grain crop of all types, avoiding the restrictions imposed by the conventional need to concentrate large volumes of cut crop through a processing stage which is much narrower than the cut width.

### SUMMARY OF THE INVENTION

According to one aspect of the invention, there is provided a cutting and threshing header for attachment to an agricultural vehicle for use in harvesting standing crops, the cutting and threshing header comprising:
cutting means for cutting crop material including seeds or grains and varying lengths of stalk, said cutting means extending over substantially the full width of the header; and
threshing means extending over a width within said header substantially equal to the width of the cutting means, and wherein said threshing means comprises:
a curved mesh surface extending over the full width of the threshing means; and
a rotor co-operating with said mesh surface to urge the cut crop material through an annular space between the rotor and the mesh, thereby causing separation of said cut crop material into seeds or grains, which pass through said mesh for collection, and waste material including said varying lengths of stalk, which is discharged from the threshing means over substantially the full width thereof.

According to another aspect of the invention, there is provided a harvesting machine comprising a cutting and threshing header for use in harvesting standing crops, and an agricultural vehicle attached to said cutting and threshing head, the cutting and threshing header comprising:
cutting means for cutting crop material including seeds or grains and varying lengths of stalk, said cutting means extending over substantially the full width of the header; and
threshing means extending over a width within said header substantially equal to the width of the cutting means, and wherein said threshing means comprises:
a curved mesh surface extending over the full width of the threshing means; and
a rotor co-operating with said mesh surface to urge the cut crop material through an annular space between the rotor and the mesh, thereby causing separation of said cut crop material into seeds or grains, which pass through said mesh for collection, and waste material including said varying lengths of stalk, which is discharged from the threshing means over substantially the full width thereof.

The cutting means may comprise fixed blades with means for urging the crop into the blades. Preferably, shear blades are employed which reciprocate relative to fixed blades.

The threshing means may comprise a rotary beater and a fixed grid, the cut crop moving between the beater and the grid. Seeds or grains falling through the grid may be collected and transported by transverse conveyor means, which may move the seeds/grains to one end of the cutting head, or to a central collecting point therein. The waste crop material may be discharged to the ground, or passed to one or more further threshing stages external of the cutting head.

By threshing over the full width of the cutting means, the volume of material being handled over a given width of the threshing means is substantially reduced, permitting a higher extraction efficiency in length terms, and thus making it practical to incorporate the threshing stage into the cutting head. Moreover, the header can cut substantially the full length of the crop, rather than just the grain- or seed-carrying portion, permitting the processing of the whole of the crop in one pass. The header can offer the possibility of gathering the straw for collection and subsequent use, or chopping it across the full width of the header, to be discharged uniformly over the ground for incorporation into the soil. It would be possible to do this by a separate operation or by a plow trailed behind the agricultural vehicle propelling the header

The cutting header of the invention may be installed as a replacement for the conventional cutting header of a combine harvester, or it may be mounted on a suitable vehicle having the ability to supply power to the head. Drive of the cutter and thresher in the header may be provided by hydraulic motors supplied with hydraulic power from the supporting vehicle, although mechanical drive may also be possible using a power take-off from the supporting vehicle. In an alternative embodiment of the invention, the cutter and thresher are driven by a separate engine mounted thereon.

### BRIEF DESCRIPTION OF THE DRAWINGS

In the drawings, which illustrate an exemplary embodiment of the invention:

FIG. 1 is a perspective view of the cutting header with the drive and supporting means omitted for the sake of clarity;

FIG. 2 is a side elevation of the cutting header shown in FIG. 1;

FIG. 3 is a diagrammatic side elevation of an alternative design of spool or rotor in conjunction with the cutting bar;

FIG. 4 is a side elevation of an alternative beating rotor;

FIG. 5 is a top plan view of the cutting head, omitting the rotor;

FIG. 6 is an enlarged view of a section of the rotor shown in FIG. 3; and

FIG. 7 is a part-sectional elevation of the threshing part of a cutting and threshing header according to another embodiment of the invention.

### DETAILED DESCRIPTION OF THE ILLUSTRATED EMBODIMENTS

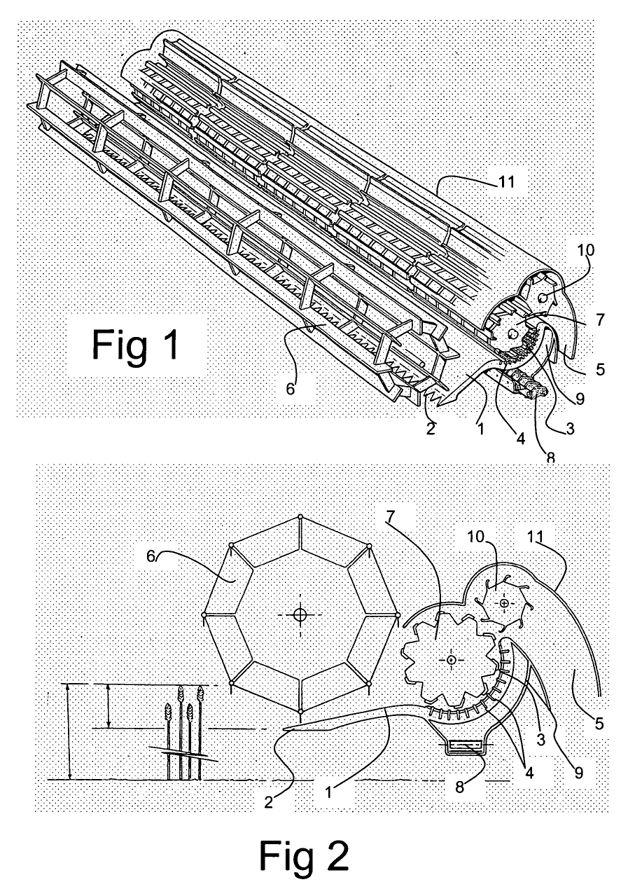

Referring first to FIGS. 1 and 2, the cutting header comprises a forwardly-projecting cutting blade 1 divided into a plurality of teeth 2, the blade leading into a threshing section having a mesh grid 3 with transversely-extending bars 4 set into it. An ejection chute 5 is located rearwardly of the threshing section to discharge waste material on to the ground. A flail rotor 6 is mounted for rotation above the blade 1 so as to urge the crop on to the teeth 2, where the uppermost parts of the crop stalks are cut. The flail 6 also serves to urge or project the cut material towards the threshing section, where a beater rotor 7 draws the material in and beats the material as it passes over the grid 3 and bars 4. This action liberates the grain or seeds in the crop, allowing them to fall through the grid on to a transverse conveyor 8 which transports the grain/seeds to a collection point at one end of the cutting head. A curved guide 9 directs the grain from other parts of the grid 3 on to the conveyor 8. A lifting rotor 10 lifts the waste crop material emerging from the threshing section and delivers it into the chute 5. An upper cover 11 encloses the threshing section and forms the other half of the ejection chute 5.

It will be seen from FIG. 1 that the beater rotor 7 and the lifting rotor 10 are each formed from a series of shorter sections, permitting the threshing section of the cutting header to be assembled into any of a range of different modular widths.

FIG. 2 in particular shows how the cutting header may be positioned so as to cut the crop at a height which captures all the seed/grain-bearing parts while minimizing the additional material collected, thus also minimizing the work needing to be done by the threshing section. Control of the height of the cutting header is suitably achieved by detecting the uppermost height of the crop as a whole and then positioning the blade 1 at a predetermined distance below the uppermost height detected. This is preferably carried out dynamically, so that variations in the crop height across a field are accommodated.

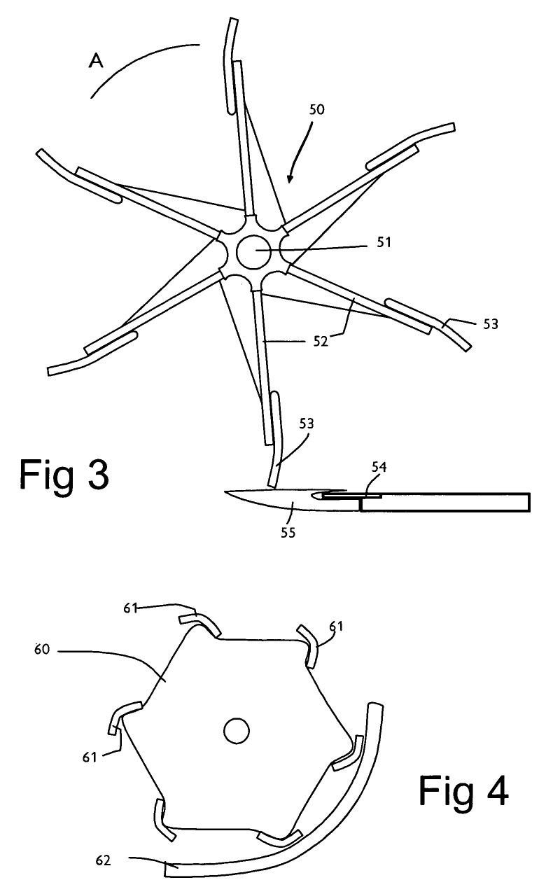

Referring now to FIG. 3, the spool or rotor 50 comprises a hub 51 mounting a plurality of laterally-spaced sets of six arms 52, corresponding pairs of arms in adjacent sets carrying between them a vane 53 which is curved rearwards relative to the direction of rotation so as to present a generally vertical face to the crop as it is engaged by the cutting blades 54 and 55. The spool 50 is rotated in the direction shown by arrow A at a speed which is proportional to the ground speed of the supporting vehicle, the vanes serving not only to guide the crop into contact with the cutting blades 54 and 55, but also to propel the cut crop rearwardly towards the threshing section. The cutting blades comprise fixed, generally triangular blades 54 secured to the leading edge of the cutting head, and laterally reciprocable blades 55 which partially overlap the fixed blades 54 in a vertical direction.

FIG. 4 shows a modified beater rotor 60 in the threshing section of the cutting head. The rotor is of generally hexagonal configuration and mounts a beater bar 61 along each corner of the hexagon. The beater bars 61 are curved and have a plurality of angled grooves cut in the external face thereof, the grooves in one bar being angled in the opposite sense to those in the adjacent bars. The bars act against a curved mesh surface 62 such that grain falls through while the remainder of the crop material is carried upwardly for disposal. The grain (and a certain amount of chaff and the like) falls on to a laterally-extending conveyor. It may then be either be carried into a conventional combine harvester for final separation, or conveyed to a further separation stage mounted above the threshing section, in which it is again transported laterally while being tumbled in an air stream to carry away the chaff for disposal, leaving the clean grain to be delivered at the end of the separation stage, i.e. at the side of the cutting head.

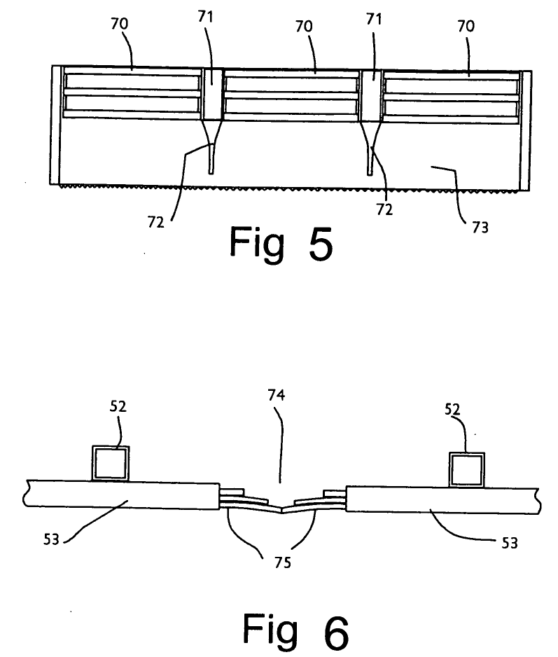

FIG. 5 shows an alternative configuration of the cutting head, in which the threshing section is divided into three lateral sections to improve the support of the beater rotor and to simplify its construction. The arrangement also permits individual sections to be removed for repair or replacement. The outer two of the three individual beater rotor sections 70 are mounted between the sides of the cutting header and intermediate bearing supports 71, while the inner rotor section 70 is carried solely between the supports 71. To guide the cut crop away from the bearing supports 71, two tapered guides 72 are mounted in front of the supports 71 on the lower surface 73 of the cutting head. To permit the spool 50 to pass over the guides 72, the vanes 53 are mounted so as to leave lateral gaps 74 between them, as may be seen from FIG. 8. However, since the gaps 74 would leave parts of the crop unguided before and during cutting, reducing efficiency of harvesting, the gaps are filled by mounting a series of rubber blades 75 in the ends of the vanes 53, the blades in each series being stepped so that one pair meet, while the other blades serve as support without meeting. As the spool rotates, the blades 75 separate as they pass over the guides 72 and then close again as they clear the guides, ensuring that a continuous vane surface is presented to the crop on the next rotation.

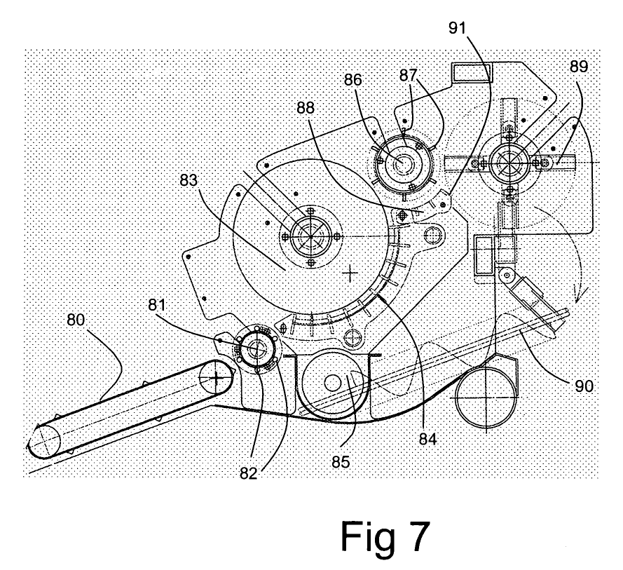

Referring to FIG. 7, the header has a conveyor belt 80 to convey cut material from a forwardly-extending reciprocating cutter bar with guiding teeth as shown at 1 in FIG. 1, for example, but moved forward. A spool/flail arrangement, as illustrated at 6 in FIG. 1, may also be provided to guide the cut material on to the conveyor 80. The cut material is picked up by a lifting roller 81 having longitudinal lifting bars 82 spaced around the circumference thereof and urged into the annular space between a beater roller 83 and a curved mesh screen 84, arranged so that the gap between the roller 83 and the screen 84 reduces, for example from about 13 mm at the entrance thereto to 3 mm at the exit. The beater roller 83 rubs the cut material over the mesh surface, causing separation of the grains or seeds from the remainder of the crop material. The seeds drop through the mesh to be conveyed to a collecting discharge point by means of a transverse screw auger 85. The material emerging from the first threshing stage represented by the roller 83 and the mesh 84 enters a second threshing stage for removal of any residual seed or grain. The second stage consists of a smaller roller 86 having a plurality of longitudinal bars 87 projecting therefrom. The roller 86 is spaced from a secondary mesh screen 88 by a larger uniform gap, for example of about 20 mm-30 mm, the bars 87 conveying the expanding mass of cut crop material through said uniform gap while exerting a beating action to assist in the final separation process. Seed or grain separated in the second threshing stage also falls into the screw auger 85.

The waste material emerging from the second threshing stage is discharged over the full width of the threshing stage, essentially the full width of the header, to pass into a straw chopper consisting of rotating blades or flails 89 which extend over substantially the full width of the header. The blades cooperate with a fixed blade 91 to chop the waste material into short lengths. The chopped straw then drops on to the ground, again uniformly over the width of the header, for subsequent incorporation into the soil, again in conventional manner. The fixed blade 91 is mounted in the header in such a manner as to be pivotable rearwardly out of position when chopping of the straw is not required. In this case, the rotational speed of the flails 89 is reduced so that they act merely to urge the material out of the secondary threshing stage to pass uncut on to a transverse conveyor or auger trough (not shown) which can be inserted into the header beneath the rotating blades or flails 89. The conveyor or trough guides the waste material to be discharged to one or both sides of the header. In this manner, the straw falls on to the ground in rows for collection and baling if the straw is to be retained for subsequent use.

I claim:

1. A cutting and threshing header for attachment to an agricultural vehicle for use in harvesting standing crops, the cutting and threshing header comprising:
cutting means for cutting crop material including seeds or grains and varying lengths of stalk, said cutting means extending over substantially the full width of the header; and
threshing means extending over a width within said header substantially equal to the width of the cutting means, and wherein said threshing means includes a primary thresher comprising:
a curved mesh surface extending over the full width of the threshing means; and
a rotor co-operating with said mesh surface to urge the cut crop material through an annular space between the rotor and the mesh, thereby causing separation of said cut crop material into seeds or grains, which pass through said mesh for collection, and waste material including said varying lengths of stalk, which is discharged from the threshing means over substantially the full width thereof.

2. A cutting and threshing header according to claim 1, wherein the cutting means comprise fixed blades with means for urging the crop into the blades.

3. A cutting and threshing header according to claim 2, comprising shear blades reciprocating relative to the fixed blades.

4. A cutting and threshing header according to claim 1, comprising a transverse conveyor to collect and transport seeds or grains falling through the grid.

5. A cutting and threshing header according to claim 4, wherein the conveyor means moves the seeds/grains to one side of the header.

6. A cutting and threshing header according to claim 4, wherein the conveyor means moves the seeds/grains to a central collecting point in the header.

7. A cutting and threshing header according to claim 1, wherein the threshing means further comprises a secondary thresher receiving material from said primary thresher and acting to release further seeds from said material.

8. A cutting and threshing header according to claim 7, wherein the secondary thresher comprises a beater roller co-operating with a screen.

9. A cutting and threshing header according to claim 8, wherein the space between the beater roller and the screen in the secondary thresher is greater than the annular space in said primary thresher, whereby the waste material is caused to expand on entry to said secondary thresher.

10. A cutting and threshing header according to claim 1, further comprising straw chopping means extending over substantially the full width of the header for chopping the waste material discharged from the threshing means, the chopped waste crop material then exiting the chopping means to fall to the ground over substantially the full width of the header.

11. A cutting and threshing header according to claim 1, further comprising a transverse conveyor for receiving the waste crop material discharged from the threshing means and for conveying the material to at least one side of the header for discharge on to the ground for collection.

12. A harvesting machine, comprising a cutting and threshing header for use in harvesting standing crops, and an agricultural vehicle attached to said cutting and threshing head, the cutting and threshing header comprising:
cutting means for cutting crop material including seeds or grains and varying lengths of stalk, said cutting means extending over substantially the full width of the header; and
threshing means extending over a width within said header substantially equal to the width of the cutting means, and wherein said threshing means includes a primary thresher comprising:
a curved mesh surface extending over the full width of the threshing means; and
a rotor co-operating with said mesh surface to urge the cut crop material through an annular space between the rotor and the mesh, thereby causing separation of said cut crop material into seeds or grains, which pass through said mesh for collection, and waste material including said varying lengths of stalk, which is discharged from the threshing means over substantially the full width thereof.

13. A harvesting machine according to claim 12, wherein the cutting means comprise fixed blades with means for urging the crop into the blades.

14. A harvesting machine according to claim 12, comprising shear blades reciprocating relative to the fixed blades.

15. A harvesting machine according to claim 12, comprising a transverse conveyor to collect and transport seeds or grains falling through the grid.

16. A harvesting machine according to claim 15, wherein the conveyor means moves the seeds/grains to one end of the cutting head.

17. A harvesting machine according to claim 16, wherein the conveyor means moves the seeds/grains to a central collecting point in the cutting head.

18. A harvesting machine according to claim 12, wherein the threshing means further comprises a secondary thresher receiving material from said primary thresher and acting to release further seeds from said material.

19. A cutting and threshing header according to claim 18, wherein the secondary thresher comprises a beater roller co-operating with a screen.

20. A cutting and threshing header according to claim 19, wherein the space between the beater roller and the screen in the secondary thresher is greater than the annular space in said primary thresher, whereby the waste material is caused to expand on entry to said secondary thresher.

21. A harvesting machine according to claim 12, further comprising straw chopping means extending over substantially the full width of the header for chopping the waste material discharged from the threshing means, the chopped waste crop material then exiting the chopping means to fall to the ground over substantially the full width of the header.

22. A harvesting machine according to claim 12, further comprising a transverse conveyor for receiving the waste crop material discharged from the threshing means and for conveying the material to at least one side of the header for discharge on to the ground for collection.
